(19) United States
(12) Patent Application Publication
(10) Pub. No.: US 2005/0271359 A1
(43) Pub. Date: Dec. 8, 2005

(54) Content copying apparatus

(75) Inventor: Eiji Nakai, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SANYO ELECTRIC CO., LTD., Moriguchi-shi (JP)

(21) Appl. No.: 11/141,016

(22) Filed: Jun. 1, 2005

(30) Foreign Application Priority Data
Jun. 4, 2004 (JP) 2004-166825

(51) Int. Cl. H04N 5/76; G11B 5/86; G11B 27/00

(52) U.S. Cl. 386/52; 360/15

(57) ABSTRACT

A content copying apparatus includes a flash memory. The flash memory stores attribute information for contents copied to a DVD, out of a plurality of contents recorded on a hard disk (HD). A deletion supporting screen based on such attribute information is displayed on a TV monitor. An operator determines through this screen whether or not each of the copied contents is necessary and, if none of the copied contents are necessary, performs an operation of collectively deleting all the copied contents. In response to this operation, a CPU issues to an HD drive an instruction for collectively deleting all the copied contents from the HD.

### BACKGROUND OF THE INVENTION

1. Field of the Invention

The present invention relates to a content copying apparatus. More specifically, the present invention relates to a content copying apparatus which copies to an external recording medium an arbitrary one of a plurality of contents recorded on an internal recording medium.

2. Description of the Prior Art

Conventionally, there have been provided recorders comprising both a hard disk drive and a DVD drive. Such a conventional type of recorder records a content received by a tuner on a hard disk, and copies to a DVD an arbitrary one of a plurality of contents recorded on the hard disk. Then, when its vacant capacity becomes low, it deletes an arbitrary one of the plurality of contents recorded on the hard disk. In the process of deletion, generally, the recorder displays a list screen of contents in the hard disk, accepts on the list screen a selection operation for selecting each content desired, typically to be copied to a DVD, and deletes the selected content from the hard disk.

Additionally, as another apparatus of this conventional type, there is known an automatic transaction device disclosed in Japanese Patent Laid-open No. 2000-20793 laid-open on Jan. 21, 2000. This prior art copies each of a plurality of log files (transaction records) recorded on a hard disk to two different magneto-optical disks at each one time. The log files copied thus twice are stored in a “waiting-for-deletion” directory, and are deleted from the hard disk when a predetermined period of time has passed. Incidentally, each of the log files is recorded on two magneto-optical disks for the purpose of reducing the possibility of loss of the log files through disk breakage.

As described above, with the conventional recorder, an operator needs to delete copied contents one by one, recalling his memories. Meanwhile, in the apparatus disclosed in Japanese Patent Laid-open, copied log files are stored in the “waiting-for-deletion” directory and deleted automatically from the hard disk afterward. Hence, it is conceivable that, in the conventional recorder, the copied contents are registered on a table and automatically deleted from the hard disk.

However, contents recorded by the recorder are diversified and their utilizations are not the same. More specifically, although many of the contents may be deleted from the hard disk once they have been copied to DVDs, some of them are required to remain saved in the hard disk even after copying.

### SUMMARY OF THE INVENTION

Therefore, it is a primary object of the present invention to provide a novel content copying apparatus.

It is a first specific object of the present invention to provide a content copying apparatus which can accurately determine whether a copied content is necessary or not.

It is a second specific object of the present invention to provide a content copying apparatus which can easily delete an unnecessary copied content.

The present invention of claims 1 to 7 is directed to the first object and the present invention of claims 8 and 9 is devoted to the second object.

A content copying apparatus according to claim 1 comprises: a copier for copying to an external recording medium an arbitrary one of a plurality of contents recorded on an internal recording medium; a discriminator for discriminating a recording type of the external recording medium to which copying is performed by the copier; a generator for generating copied content information in which an attribute of the content copied by the copier and the recording type discriminated by the discriminator are described; and an outputter for outputting supporting information for supporting an operation of deleting the copied content recorded on the internal recording medium based on the copied content information generated by the generator.

The copier copies to the external recording medium an arbitrary one of the plurality of contents recorded on the internal recording medium. At this time, the discriminator discriminates the recording type of the external recording medium to which copying is performed, and the generator generates the copied content information. Described in the copied content information are the attribute of the content copied by the copier and the recording type discriminated by the discriminator. The outputter outputs the supporting information for supporting an operation of deleting the copied content recorded on the internal recording medium based on the copied content information generated by the generator.

Referring to the output supporting information makes it possible to know the attribute of the copied content and the recording type of the external recording medium to which copying is performed, and thus it can be determined whether the copied content is necessary or not.

A content copying apparatus according to the present invention of claim 2 depends on claim 1. The outputter outputs the supporting information in different forms according to the recording type described in the copied content information.

The recording type of the external recording medium to which copying is performed can be known by intuition, which makes it possible to promptly determine whether the copied content is needed or not.

A content copying apparatus according to the present invention of claim 3 depends on claim 1 and further comprises: an acceptor for accepting a deletion instruction in which a desired recording type is designated; and a deleter for collectively deleting from the internal recording medium the contents copied to the external recording medium of the designated recording type when the acceptor has accepted the deletion instruction.

Simply by inputting the deletion instruction in which a desired recording type is designated, the applicable copied contents can be collectively deleted. Accordingly, when it has been determined that none of the contents copied to an external recording medium of a certain recording type are necessary, it is possible to delete these contents in an easy way.

A content copying apparatus according to the present invention of claim 4 depends on claim 1. The recording type defines whether the external recording medium is rewritable or not.

When it has been determined that none of the contents copied to a non-rewritable external recording medium are necessary, or when it is determined that none of the contents copied to a rewritable external recording medium are necessary, it is possible to delete all the applicable copied contents in a simple manner.

A content copying apparatus according to the present invention of claim 5 depends on claim 1. The attribute includes at least any one of content name, genre, recording date, and time length.

A content copying apparatus according to the present invention of claim 6 depends on claim 1 and further comprises: a placer for placing into a copied contents list attribute information of the content copied by the copier; and a collective deleter for deleting all the copied contents from the internal recording medium by referring to the copied contents list when a collective deletion operation has been accepted.

Just by performing the collective deletion operation, it is possible to collectively delete the copied contents from the internal recording medium. As a consequence, when it has been determined from the supporting information that none of the copied contents are necessary, all of them can be easily deleted.

A content copying method according to the present invention of claim 7 comprises: a copying step of copying to an external recording medium an arbitrary one of a plurality of contents recorded on an internal recording medium; a determining step of determining a recording type of the external recording medium to which copying is performed in the copying step; a generating step of generating copied content information in which an attribute of the content copied in the copying step and the recording type determined in the determining step are described; and an outputting step of outputting supporting information for supporting an operation of deleting the copied content recorded on the internal recording medium based on the copied content information generated in the generating step.

A content copying apparatus according to claim 8 comprises: an copier for copying to an external recording medium an arbitrary one of a plurality contents recorded on an internal recording medium; a placer for placing into a copied contents list attribute information of the content copied by the copier; and a collective deleter for deleting all the copied contents from the internal recording medium by referring to the copied contents list when a collective deletion operation has been accepted.

The copier copies to the external recording medium an arbitrary one of the plurality of contents recorded on the internal recording medium. At this time, the placer places into the contents list the attribute information of the content copied by the copier. The collective deleter deletes all the copied contents from the internal recording medium by referring to the copied contents list when a collective deletion operation has been accepted.

When none of the copied contents are necessary, it is possible to easily delete all of them from the internal recording medium by the collective deletion operation.

A content copying method according to the present invention of claim 9 comprises: a copying step of copying to an external recording medium an arbitrary one of a plurality of contents recorded on an internal recording medium; a placing step of placing into a copied contents list attribute information of the content copied in the copying step; and a collective deleting step of deleting all the copied contents from the internal recording medium by referring to the copied contents list when it has accepted an collective deletion operation.

According to the present invention, it is possible to appropriately determine whether a copied content is necessary or not based on the supporting information. Also, it is possible to easily delete the copied content that has been determined to be unnecessary.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a structure of a recorder of one embodiment of the present invention;

FIG. 2 is an illustrative view showing a contents table;

FIG. 3 is an illustrative view showing a dubbed contents table;

FIG. 4 is an illustrative view showing one example of content deletion supporting screen;

FIG. 5 is an illustrative view showing another example of content deletion supporting screen;

FIG. 6 is an illustrative view showing still another example of content deletion supporting screen;

FIG. 7 is an illustrative view showing further another example of content deletion supporting screen;

FIG. 8 is an illustrative view showing another example of content deletion supporting screen;

FIG. 9 is an illustrative view showing still another example of content deletion supporting screen;

FIG. 10 is an illustrative view showing further another example of content deletion supporting screen;

FIG. 11 is an illustrative view showing another example of content deletion supporting screen;

FIG. 12 is an illustrative view showing still another example of content deletion supporting screen;

FIG. 13 is an illustrative view showing further another example of content deletion supporting screen;

FIG. 14 is an illustrative view showing another example of content deletion supporting screen;

FIG. 15 is an illustrative view showing still another example of content deletion supporting screen;

FIG. 16 is an illustrative view showing further another example of content deletion supporting screen;

FIG. 17 is an illustrative view showing another example of content deletion supporting screen;

FIG. 18 is a flowchart showing one part of CPU operation;

FIG. 19 is a flowchart showing another part of CPU operation;

FIG. 20 is a flowchart showing still another part of CPU operation;

FIG. 21 is a flowchart showing further another part of CPU operation;

FIG. 22 is a flowchart showing another part of CPU operation;

FIG. 23 is a flowchart showing still another part of CPU operation;

FIG. 24 is a flowchart showing further another part of CPU operation;

FIG. 25 is a flowchart showing another part of CPU operation;

FIG. 26 is a flowchart showing still another part of CPU operation;

FIG. 27 is a flowchart showing further another part of CPU operation;

FIG. 28 is a flowchart showing another part of CPU operation;

FIG. 29 is a flowchart showing still another part of CPU operation;

FIG. 30 is a flowchart showing further another part of CPU operation; and

FIG. 31 is a flowchart showing another part of CPU operation.

### DETAILED DESCRIPTION OF THE PREFERRED EMBODIMENTS

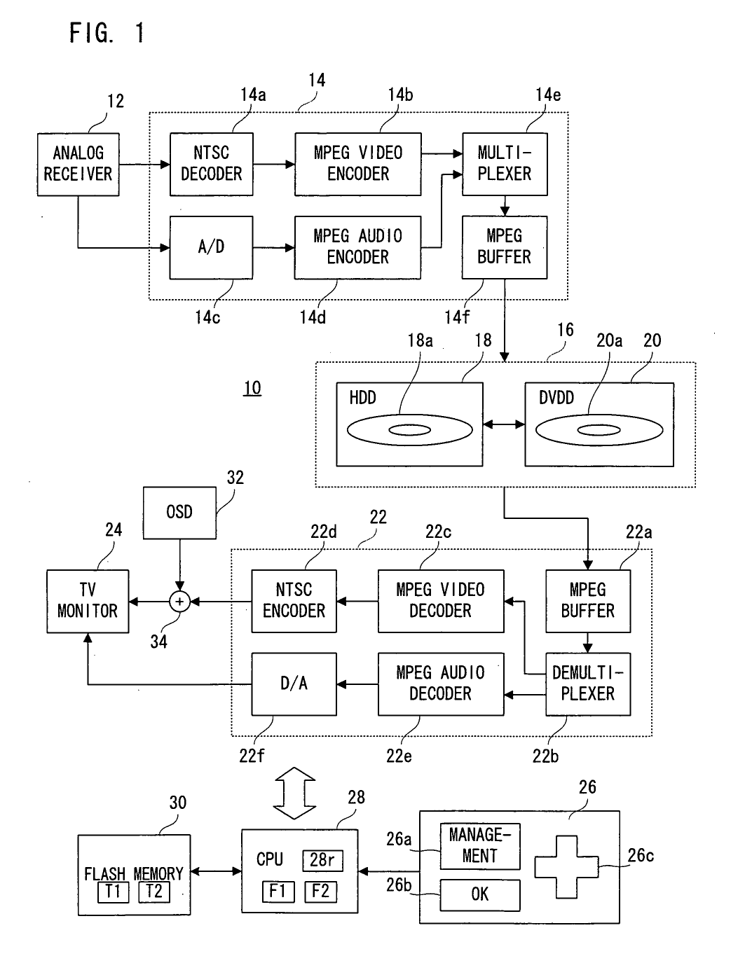

Referring to FIG. 1, a recorder 10 of this embodiment includes an analog receiver 12, an HDD (Hard Disk Drive) 18 and a DVDD (DVD Drive) 20. The analog receiver 12 receives a high-frequency television signal from an antenna (not illustrated), and outputs a composite video signal and an audio signal for a desired channel. The composite video signal is supplied to an NTSC decoder 14a forming an input processing circuit 14, and the audio signal is supplied to an A/D converter 14c forming the same circuit 14.

The NTSC decoder 14a decodes the supplied composite video signal and outputs video data. Meanwhile, the A/D converter 14c subjects the audio signal to A/D conversion and outputs audio data. The output video data and audio data are provided to an MPEG video encoder 14b and an MPEG audio encoder 14d, respectively. With this, the video data is converted by the MPEG video encoder 14b into a video PES (Packetized Elementary Stream), and the audio data is converted by the MPEG audio encoder 14d into an audio PES.

A multiplexer 14e generates an MPEG-PS (Program Stream) by multiplexing the video PES and the audio PES output from the MPEG video encoder 14b and the MPEG audio encoder 14d, and supplies the generated MPEG-PS to the HDD 18 via an MPEG buffer 14f.

Receiving a recording instruction from a CPU 28, the HDD 18 generates an image file in which the MPEG-PS is stored, on a built-in hard disk 18a. In this manner, images and sounds for the desired program are recorded on the hard disk 18a. In a state where no recording instruction is issued, that is, in a non-recording mode, the MPEG-PS is written into a temporary file on the hard disk 18a and a process of reading out the MPEG-PS from the temporary file is carried out.

When a reproducing instruction for the desired program has been issued from the CPU 28, the MPEG-PS is reproduced by the HDD 18 from the image file recorded on the hard disk 18a. The reproduced MPEG-PS is supplied to a demultiplexer 22b via an MPEG buffer 22a forming an output processing circuit 22. The demultiplexer 22b extracts the video PES and the audio PES from the supplied MPEG-PS, and supplies the video PES and the audio PES to an MPEG video decoder 22c and an MPEG audio decoder 22e, respectively.

The MPEG video decoder 22c decodes the supplied video PES to generate video data, and provides the generated video data to an NTSC encoder 22d. The video data is converted by the NTSC encoder 22d into a composite video signal. The converted composite video signal is then output to a television monitor 24. As a result, the reproduced images for the desired program are displayed on the television monitor 24.

The MPEG audio decoder 22e decodes the supplied audio PES to generate audio data. The generated audio data is converted by an audio D/A converter 22f into an analog audio signal. The converted audio signal is output to the television monitor 24. Consequently, the reproduced sounds for the desired program are output through a speaker of the television monitor 24.

Additionally, in a state where no reproduction instruction is issued, that is, in a non-reproduction mode, the MPEG-PS read out from the temporary file on the hard disk 18a is reproduced, and thus reproduced images and reproduced sounds for a program received at this point in time by the analog receiver 12 are output.

When a dubbing instruction for the desired program has been issued from the CPU 28, the DVDD 20 copies the image file from the hard disk 18a to a DVD 20a. By this dubbing process, the image file is formed on both the hard disk 18a and the DVD 20a. The image file formed on the hard disk 18a or the DVD 20a will be hereinafter called “content”.

The DVDD 20 here supports a plurality of recording types, more specifically, both a recordable type (R type) and a rewritable type (RW type). On this account, it is possible to use these two types of DVDs in different ways as appropriate, such as dubbing archived contents on the DVD-R and dubbing non-archived contents on the DVD-RW.

When a deletion instruction for the desired program has been issued from the CPU 28, the HDD 18 deletes the relevant content from the hard disk 18a. Also, when a collective deletion instruction for the dubbed programs has been issued from the CPU 28, the HDD 18 collectively deletes all the dubbed contents from the hard disk 18a. Besides, it is possible to collectively delete only the contents dubbed on the R type DVD 20a (hereinafter called “R” dubbed contents) or collectively delete only the contents dubbed on the RW type DVD 20a (hereinafter called “RW” dubbed contents).

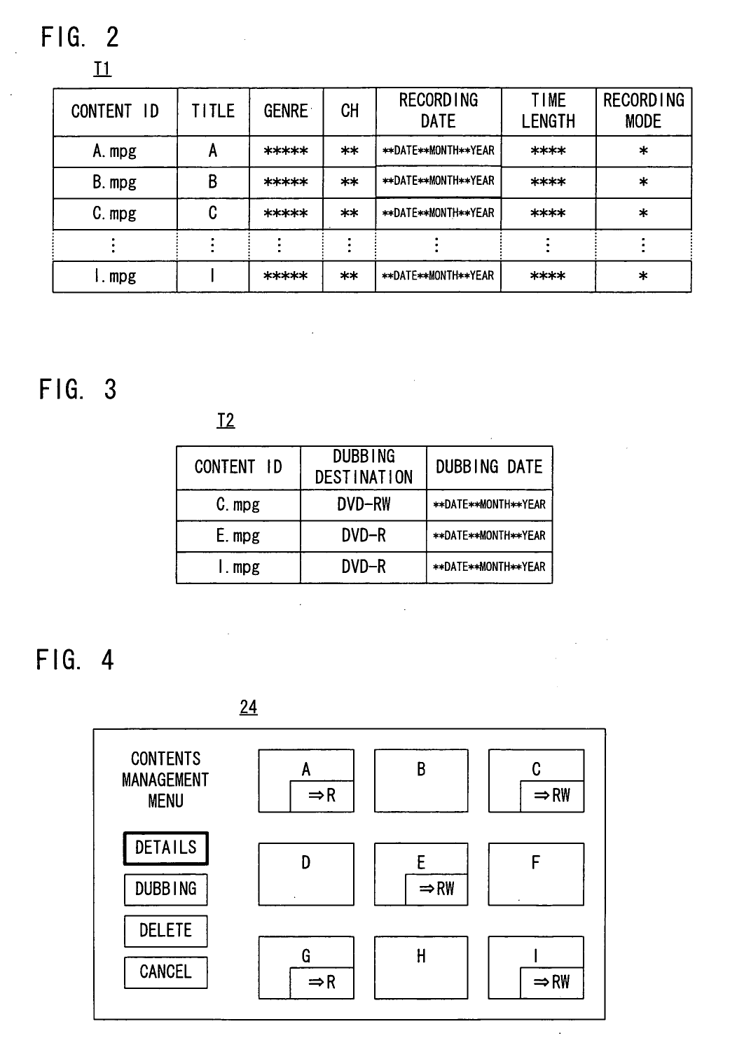

A flash memory 30 stores a contents table T1 as shown in FIG. 2 and a dubbed contents table T2 as shown in FIG. 3. Referring to FIG. 2, registered on the contents table T1 is information including content ID, title, and recording date for each of the contents recorded on the hard disk 18a. Referring to FIG. 3, registered on the dubbed contents table T2 are a dubbing destination, i.e., DVD type, and dubbing date for each of the dubbed contents out of the contents recorded on the hard disk 18a.

An OSD (On Screen Display) circuit 32 generates a character signal under an instruction from the CPU 28. After it has been output from the OSD circuit 32, the character signal is mixed with a composite video signal from the NTSC encoder 22d in a mixing circuit 34, which causes a character to be displayed on-screen on the television monitor 24. Characters include letters, symbols, graphic forms, etc. Menu selection screens, icons and dialogues are generated by combining these characters.

On the recorder 10 structured as described above, in deleting a content from the hard disk 18a, content deletion supporting screens as shown in FIG. 4 to FIG. 17 are generated on basis of the contents table T1 and the dubbed contents table T2, and the generated screens are displayed on the television monitor 24. An operator can appropriately delete the content from the hard disk 18a by performing a deletion operation through an input device 26 according to these deletion supporting screens.

More specifically, when a management key 26a in the input device 26 is pressed, a content management menu screen is firstly displayed as shown in FIG. 4. This screen is composed of a menu containing four options “Details”, “Dubbing”, “Delete” and “Cancel” and a contents list containing a plurality of icons each corresponding to a plurality contents in the hard disk 18a. Each of the plurality of icons in the contents list is given a title of the corresponding content. In addition, the icons for the contents copied to the R type DVD 20a are each given an identification tag such as “→R” and the icons for the contents copied to the RW type DVD 20a are each given an identification tag such as “RW”.

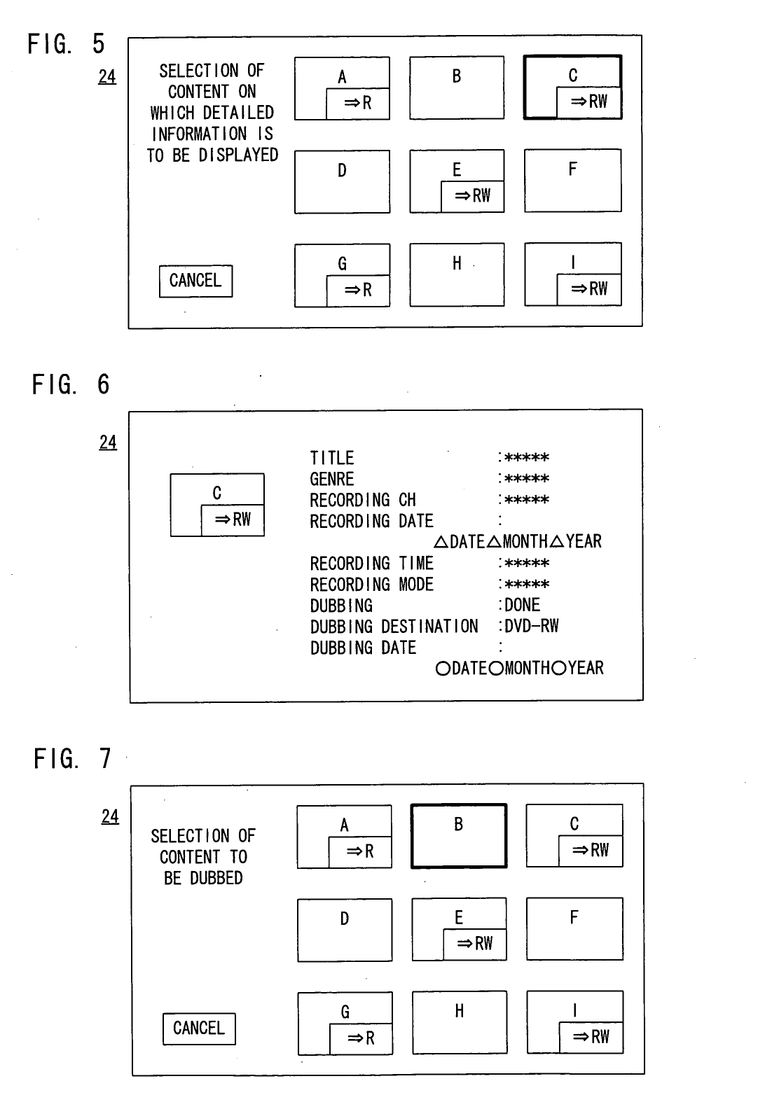

When “Details” is selected on the screen shown in FIG. 4 by operating a cursor key 26c and an OK key 26b, a content selection screen as shown in FIG. 5 is displayed. This screen contains a dialogue for selection of a content on which detailed information is to be displayed, and a contents list that is identical to that shown in FIG. 4. Additionally, when a content “C” is selected on the screen of FIG. 5, for example, detailed information on the content “C” is displayed as shown in FIG. 6. This makes it possible to easily know the title, genre, recording date, dubbing destination for an arbitrary one on the hard disk 18a.

When “Dubbing” is selected on the content management menu screen shown in FIG. 4, a content selection screen is displayed as shown in FIG. 7. This screen contains a dialogue for selection of a content to be dubbed and a contents list which is identical to that shown in FIG. 4. When a content “B” is selected on the screen of FIG. 7, for example, an image file corresponding to the content B is dubbed from the hard disk 18a to the DVD 20a. After that, the dubbing destination, i.e., the recording type of the DVD 20a is detected, and a detection result, that is, the R type or the RW type is registered on the table T2 (see FIG. 3).

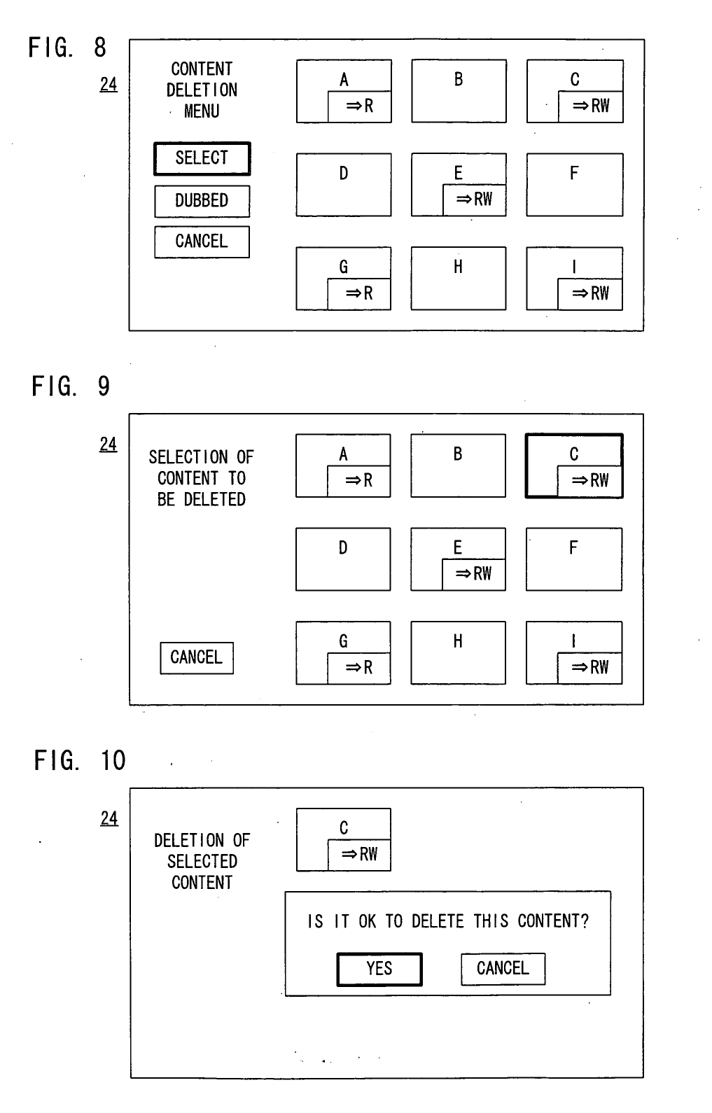

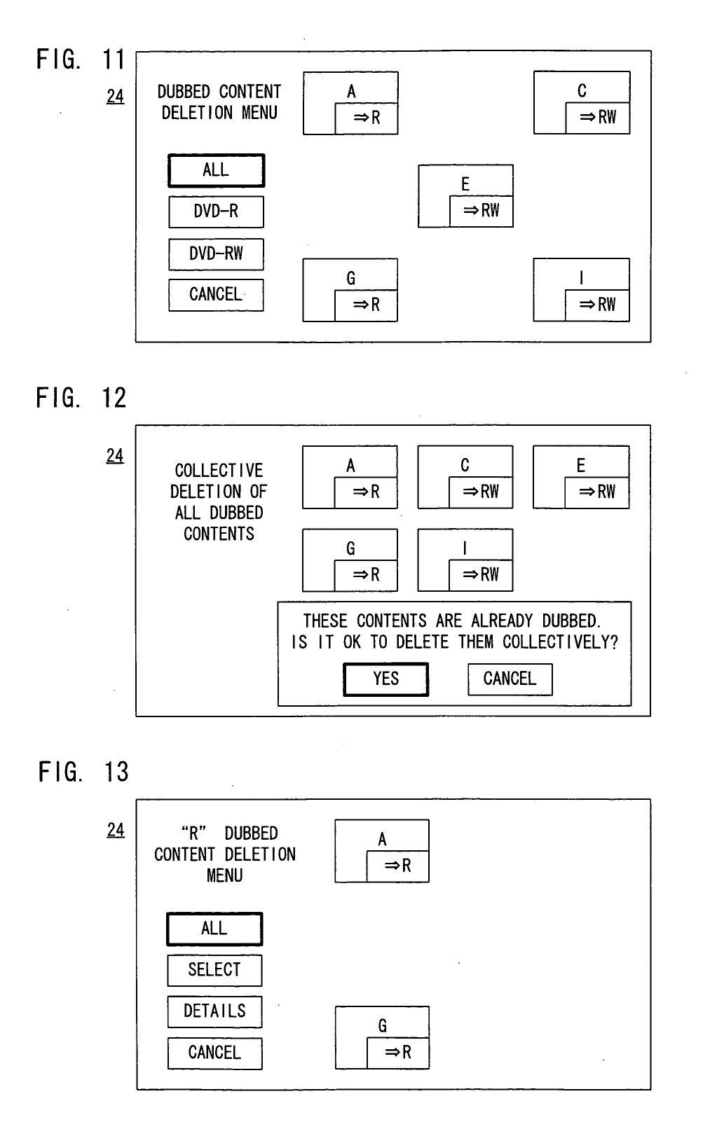

When “Delete” is selected on the content management menu screen shown in FIG. 4, a delete menu screen is displayed as shown in FIG. 8. This screen consists of a menu containing three options “Select”, “Dubbed” and “Cancel”, and a contents list that is the same as that shown in FIG. 4. When “Select” is selected on the screen of FIG. 8, a content-to-be-deleted selection screen is displayed as shown in FIG. 9. This content selection screen contains a dialogue for selection of a content to be deleted and a contents list which is the same as that shown in FIG. 4.

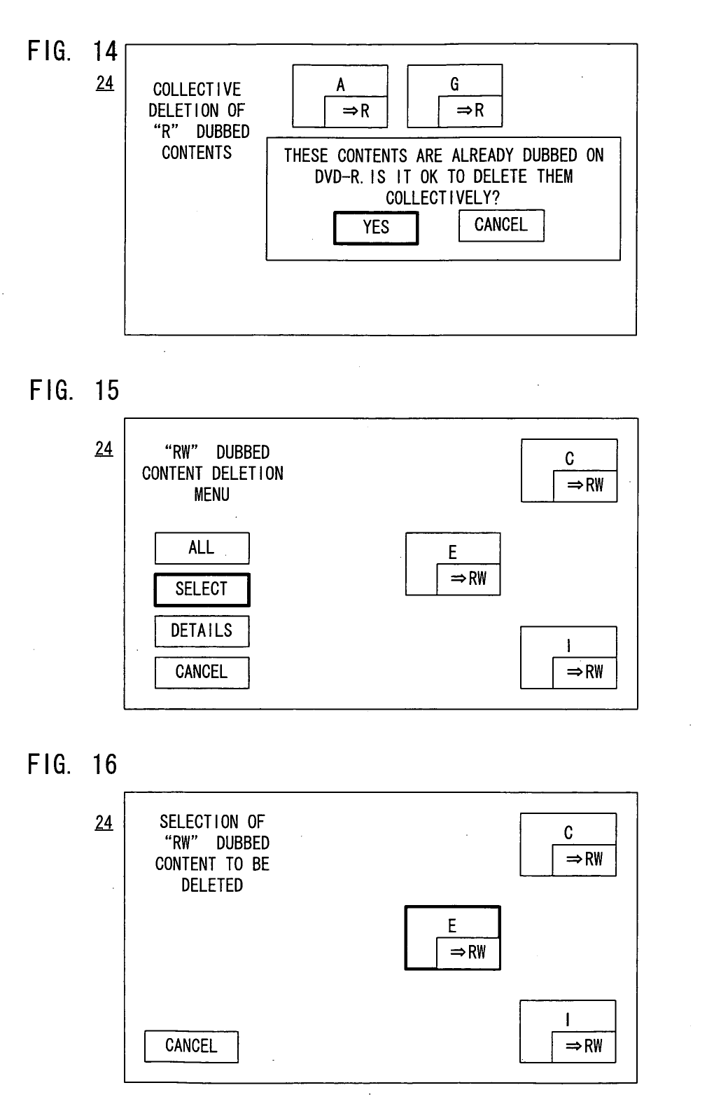

Moreover, when the content “C” is selected on the screen of FIG. 9, a content deletion screen is displayed as shown in FIG. 10. This screen consists of an icon for the content “C” and a dialogue for confirming whether or not to delete the content “C”. When “Yes” is selected here, an image file corresponding to the content “C” is deleted from the hard disk 18a. After the deletion, information corresponding to the content “C” is deleted from each of the table T1 and Table T2. With this, it is possible to properly delete an arbitrary one on the hard disk 18a.

When “Dubbed” is selected on the content deletion menu screen of FIG. 8, a dubbed content deletion menu screen is displayed as shown in FIG. 11. This screen consists of a menu containing four options “All”, “DVD-R”, “DVD-RW” and “Cancel”, and a contents list containing a plurality of icons each corresponding to a plurality of dubbed contents in the hard disk 18a.

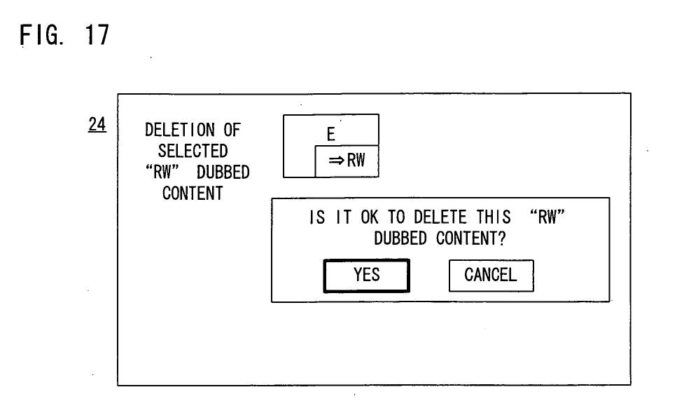

When “All” is selected on the screen of FIG. 11, an all dubbed contents collective deletion screen is displayed as shown in FIG. 12. This screen contains a contents list which is the same as that shown in FIG. 11 and a dialogue for confirming whether or not to collectively delete all the dubbed contents. When “Yes” is selected here, five image files corresponding to all the dubbed contents, i.e., contents “A”, “C”, “E”, “G” and “I” are collectively deleted from the hard disk 18a. Consequently, it is possible to delete all the dubbed contents on the hard disk 18a in an easy and reliable manner.

When “DVD-R” is selected on the dubbed content deletion menu screen of FIG. 11, an “R” dubbed content deletion menu screen is displayed as shown in FIG. 13. This screen is formed from a menu containing four options “All”, “Select”, “Details” and “Cancel”, and a contents list containing a plurality of icons each corresponding to a plurality of “R” dubbed contents in the hard disk 18a.

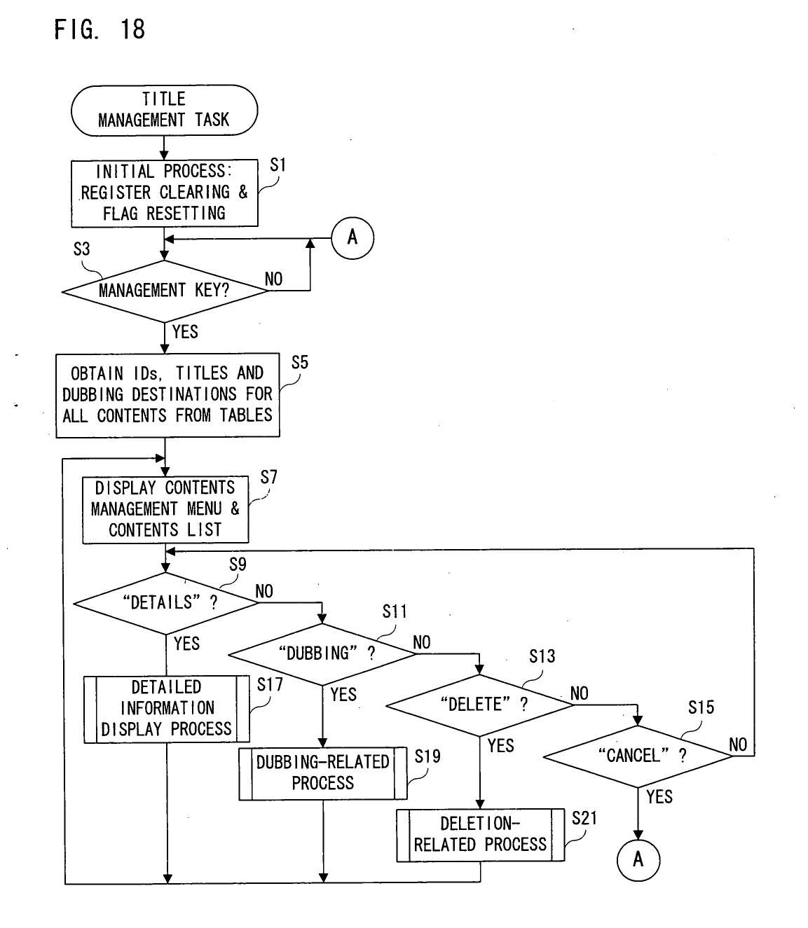

When “All” is selected on the screen of FIG. 13, an “R” dubbed contents collective deletion screen is displayed as shown in FIG. 14. This screen is composed of a contents list that is identical to that shown in FIG. 3 and a dialogue for confirming where or not to collectively delete these “R” dubbed contents. When “Yes” is selected here, two image files corresponding to the “R” dubbed contents, i.e., the contents “A” and “G” are collectively deleted from the hard disk 18a. Due to this, it is possible to delete the “R” dubbed contents from the hard disk 18a in an easy and reliable manner.

When “DVD-RW” is selected on the dubbed content deletion menu screen of FIG. 11, an “RW” dubbed content deletion menu screen is displayed as shown in FIG. 15. This screen is formed from a menu containing four options “All”, “Select”, “Details” and “Cancel”, and a contents list containing a plurality of icons each corresponding to a plurality of “RW” dubbed contents in the hard disk 18a.

When “Select” is selected on the screen of FIG. 15, a content-to-be-deleted selection screen is displayed as shown in FIG. 16. This screen consists of a dialogue for selection of an “RW” dubbed content to be deleted and a contents list that is the same as that shown in FIG. 15. When the content “E” is selected on the screen of FIG. 16, for example, a content deletion screen is displayed as shown in FIG. 17. This screen is composed of an icon for the content “E” and a dialogue for confirming whether or not to execute the deletion of the content “E”. When “Yes” is selected here, an image file corresponding to the content “E” is deleted from the hard disk 18a. Accordingly, it is possible to reliably delete the desired one of the RW dubbed contents on the hard disk 18a.

In addition, when “Details” is selected on the screen of FIG. 13, an “R” dubbed content selection screen (not illustrated) is displayed. Then, when any content is selected on this screen, detailed-information on the selected R dubbed content is displayed. Likewise, when “Details” is selected on the screen of FIG. 15, an “RW” dubbed content selection screen (not illustrated) is displayed. Then, when any content is selected on this screen, detailed information on the selected RW dubbed content is displayed. This makes it possible to check the detailed information on the dubbed content before deleting it, thereby preventing incorrect deletion.

Also, when “All” is selected on the screen of FIG. 15, an “RW” dubbed contents collective deletion screen (not illustrated) is displayed. Then, after confirmation through a dialogue, three image files corresponding to the “RW” dubbed contents, i.e., the contents “C”, “E” and “I” are collectively deleted from the hard disk 18a. Consequently, it is possible to delete the “RW” dubbed contents on the hard disk 18a in an easy and reliable manner.

In deleting a content on the hard disk 18a, the CPU 28 performs the processes in accordance with flowcharts shown in FIG. 18 to FIG. 31. Programs corresponding to these flowcharts are stored in the flash memory 30. The CPU 28 is capable of performing a plurality of tasks in parallel through control over a multitasking OS such as μITRON.

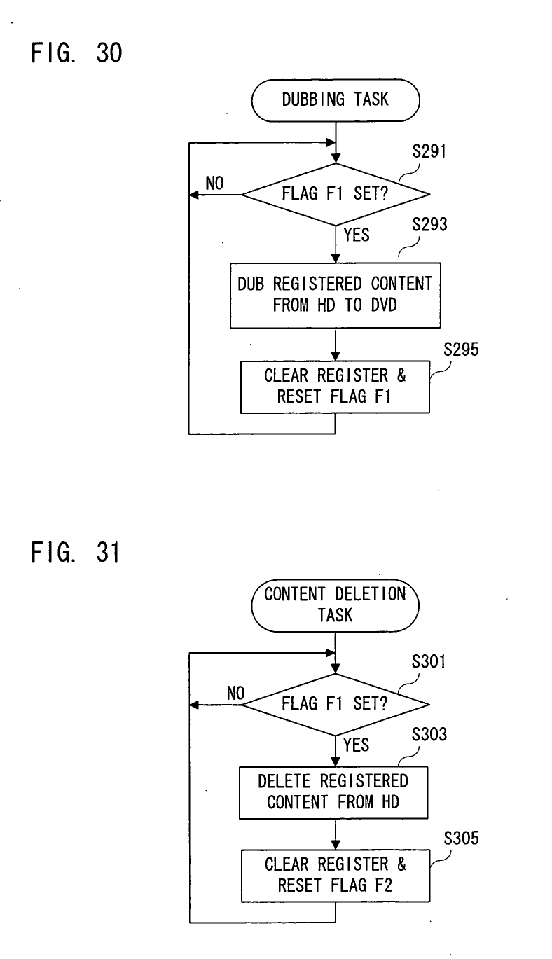

A content management task shown in FIG. 18 to FIG. 29, a dubbing task shown in FIG. 30 and a content deletion task shown in FIG. 31 are each started when the recorder 10 is turned on. Referring to FIG. 18, in the content management task, an initial process is firstly performed in a step S1. The initial process includes clearing a register 28r and resetting flags F1 and F2.

Upon completion of the initial process, the CPU 28 waits in a step S3 until the management key 26a is pressed. When the management key 26a is pressed, the CPU 28 moves to a step S5 to obtain IDs and titles of all contents from the table T1 and obtain dubbing destinations for all dubbed contents from the table T2. In a next step S7, the CPU 28 displays the content management menu together with the contents list (see FIG. 4). Then, the CPU 28 enters a loop of steps S9 to S115 to wait until any option of the options “Details”, “Dubbing”, “Deletion” and “Cancel”.

When “Details” is selected, YES is determined in the step S9 and the CPU 28 proceeds to a step S17 to perform a detailed information display process (to be hereinafter described). After that, the process returns to the step S7. When “Dubbing” is selected, YES is determined in the step S11, the CPU 28 moves to a step S19 to perform a dubbing-related process (to be described later). After that, the process returns to the step S7. When “Delete” is selected, YES is determined in the step S13 and the CPU 28 moves to a step S21 to perform a deletion-related process (to be described later). Then, the process returns to the step S7. When “Cancel” is selected, YES is determined in the step S15 and the process returns to the step S3.

Referring to FIG. 19, in the detailed information display process, the CPU 28 firstly waits for a selection operation in a loop of steps S31 and S33. When any content is selected from the contents list (see FIG. 5), YES is determined in the step S31 and the process returns to a step S35. When “Cancel” is selected, YES is determined in the step S33 and the process returns to a higher-layer routine.

In the step S35, the CPU 28 obtains detailed information on the selected content from the tables T1 and T2 (see FIG. 2 and FIG. 3), and displays the obtained detailed information (see FIG. 6). Then, the CPU 28 waits for the OK key 26b to be pressed in a step S37. When the OK key 26b has been pressed, the process returns to the loop of steps S31 to S33.

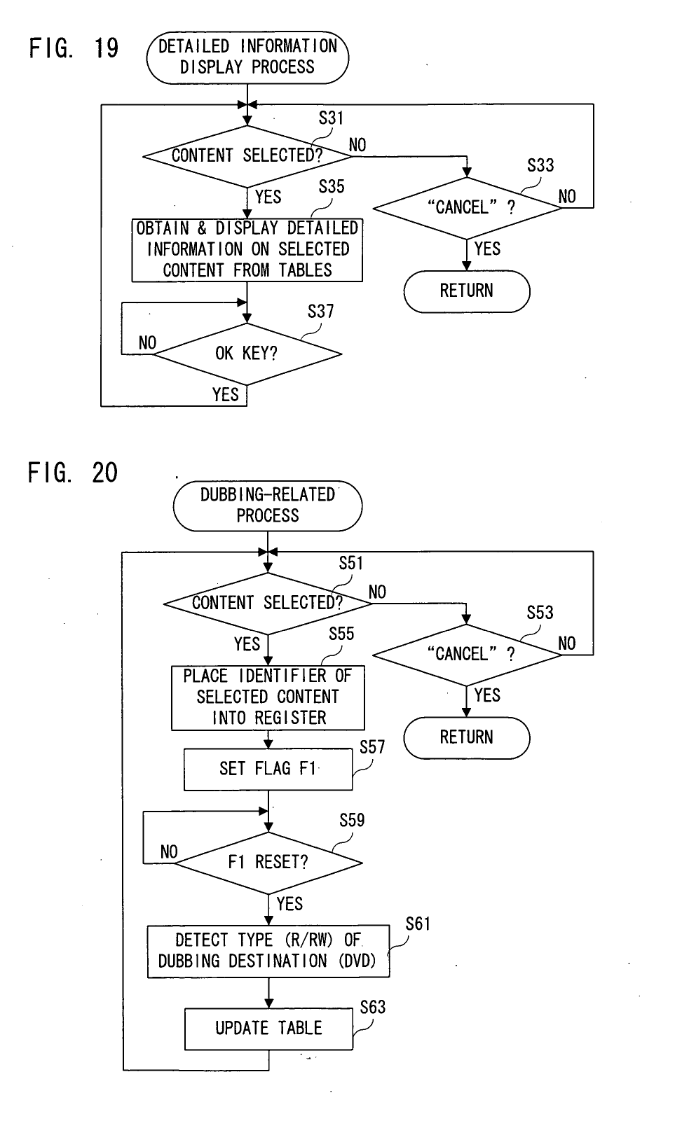

Referring to FIG. 20, in the dubbing-related process, the CPU 28 firstly waits for a selection operation in a loop of steps S51 and S53. When any content is selected from the contents list (see FIG. 7), YES is determined in the step S51 and the process moves to a step S55. When “Cancel” is selected, YES is determined in the step S53 and the process returns to a higher-layer routine.

The CPU 28 places an identifier for the selected content into the register 28r in the step S55, and sets the flag F1 in a next step S57. Then, the CPU 28 moves to a step S59 to wait until the flag F1 is reset.

When the flag F1 is reset, the CPU 28 detects in a step S61 the type of the dubbing destination, i.e., whether the DVD 20a is R type or RW type. In a next step S63, the CPU 28 updates the table T2 (see FIG. 3) according to a detection result. If the content “B” is dubbed to a DVD-R, for example, the identifier “B.mpg” and the dubbing destination “DVD-R” are newly registered on the table T2. After the table update, the CPU 28 returns to the state of waiting for the selection operation of the steps S51 and S53.

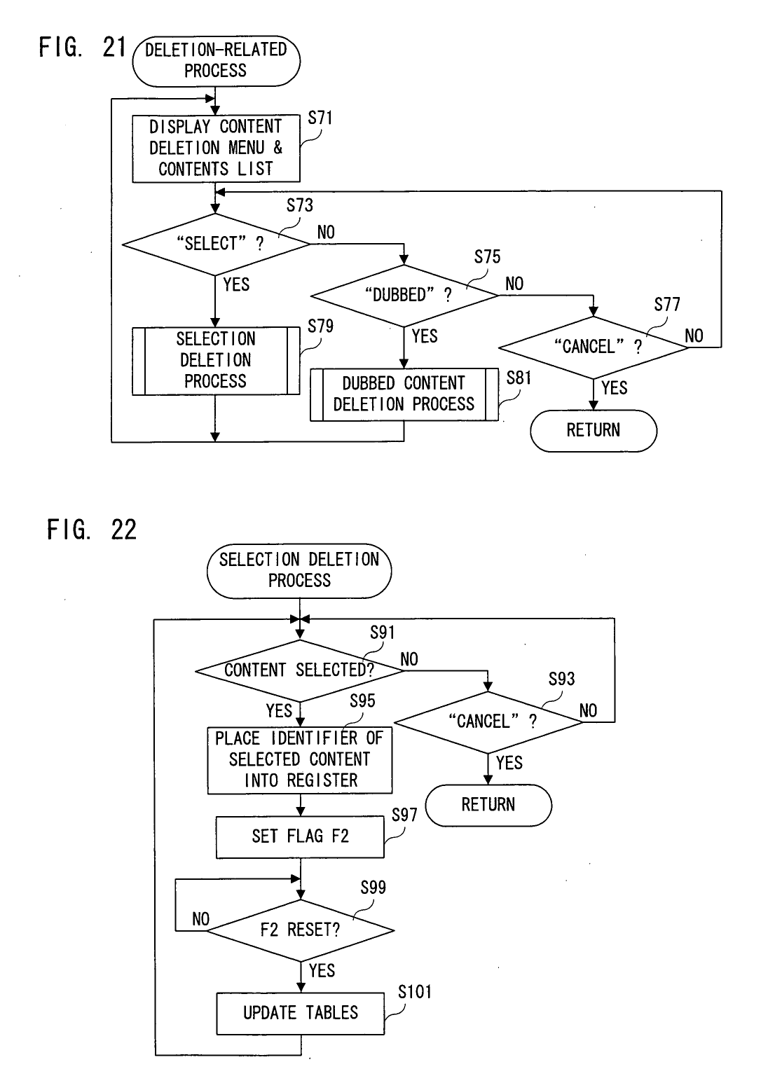

Referring to FIG. 21, in the deletion-related process, the CPU 28 firstly displays the content deletion menu together with the contents list in a step S71 (see FIG. 8). Then, the CPU 28 enters a loop of steps S73 to S77 to wait until any one of the options “Select”, “Dubbed” and “Cancel” is selected.

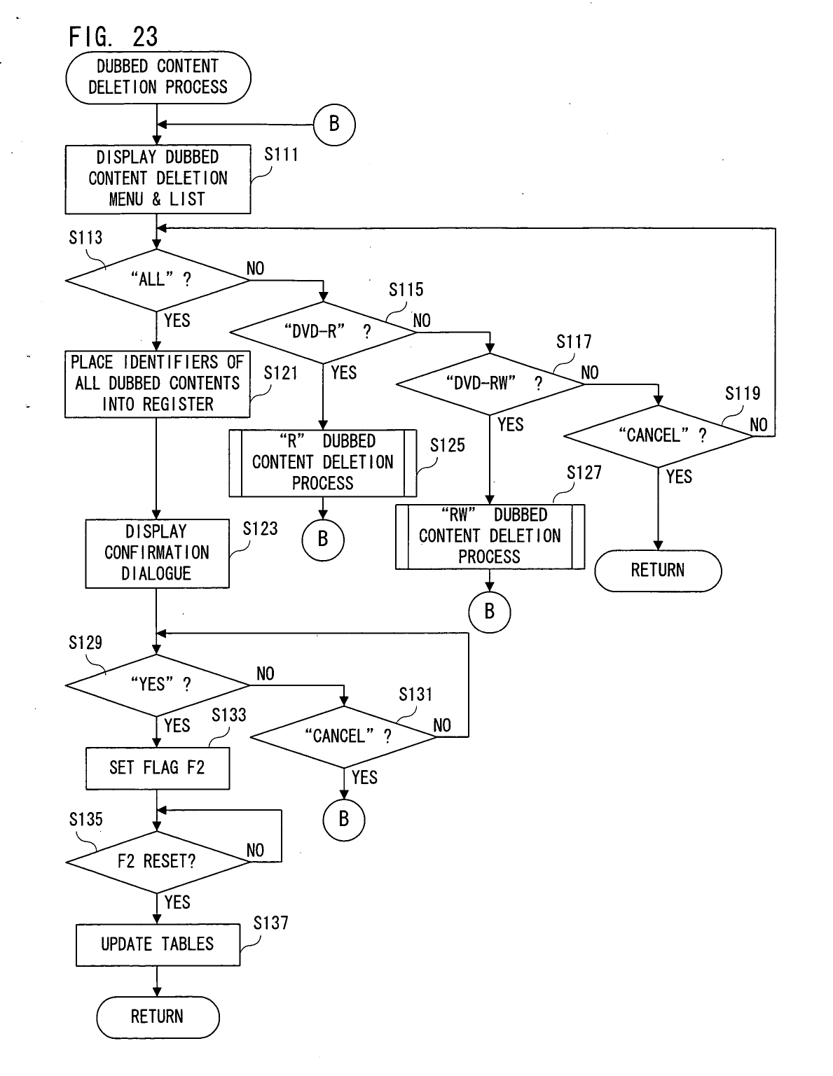

When “Select” is selected, YES is determined in the step S73 and the CPU 28 moves to a step S79 to perform a selection deletion process (see FIG. 22; to be hereinafter described). After that, the process returns to the loop of the step S73 to S77. When “Dubbed” is selected, YES is determined in the step S75 and the CPU 28 moves to a step S81 to perform a dubbed content deletion process (see FIG. 23; to be described later). After that, the process returns to the loop of the steps S73 to S77. When “Cancel” is selected, YES is determined in the step S77 and the process returns to a higher-layer routine.

Referring to FIG. 22, in the selection deletion process, the CPU 28 firstly waits for a selection operation in steps S91 and S93. When any content is selected from the contents list (see FIG. 9), YES is determined in the step S91 and the process moves to a step S95. When “Cancel” is selected, YES is determined in the step S93 and the process returns to a higher-layer routine.

The CPU 28 places the identifier for the selected content into the register 28r in the step S95 and sets the flag F2 in a next step S97. Then, the CPU 28 moves to a step S99 to wait for the flag F2 to be reset.

When the flag 2 is reset, the CPU 28 updates the tables T1 and T2 in a step S101. If the content “C” is deleted, for example, the information corresponding to the content “C” is deleted from each of the tables T1 and T2. After the table update, the CPU 28 returns to the state of waiting for the selection operation of the steps S91 and S93.

Referring to FIG. 23, in the dubbed content deletion process, the CPU 28 firstly displays the dubbed content deletion menu together with the dubbed contents list in a step S111 (see FIG. 11). Then the CPU 28 enters a loop of steps S113 to S119 to wait until any one of the options “All”, “DVD-R”, “DVD-RW” and “Cancel” is selected.

When “All” is selected, YES is determined in a step S113, the CPU 28 moves to a step S121 to place the identifiers for all the dubbed contents into the register 28r. In a next step S123, the CPU 28 displays the dialogue for confirming whether or not to collectively delete all the dubbed contents (see FIG. 12). Then, the CPU 28 enters a loop of steps S129 and S131 to wait until either “Yes” or “Cancel” is selected. When “Yes” is selected, the process proceeds to a step S133. When “Cancel” is selected, the process returns to the step S111.

The CPU 28 sets the flag F2 in the step S133 and waits for the flag F2 to be reset in a next step S135. When the flag F2 is reset, the CPU 28 moves to a step S137 to update the tables T1 and T2. With this, the information corresponding to the contents “A”, “C”, “E”, “G” and “I” is deleted from each of the tables T1 and T2. After the table update, the process returns to a higher-layer routine.

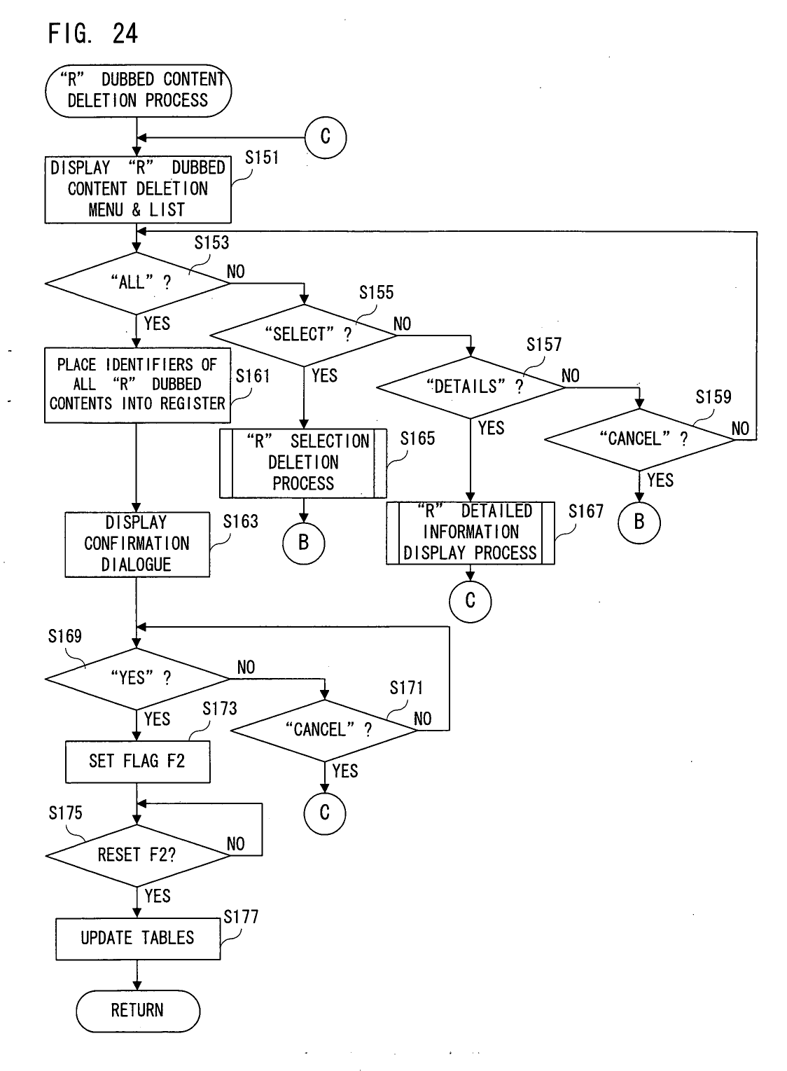

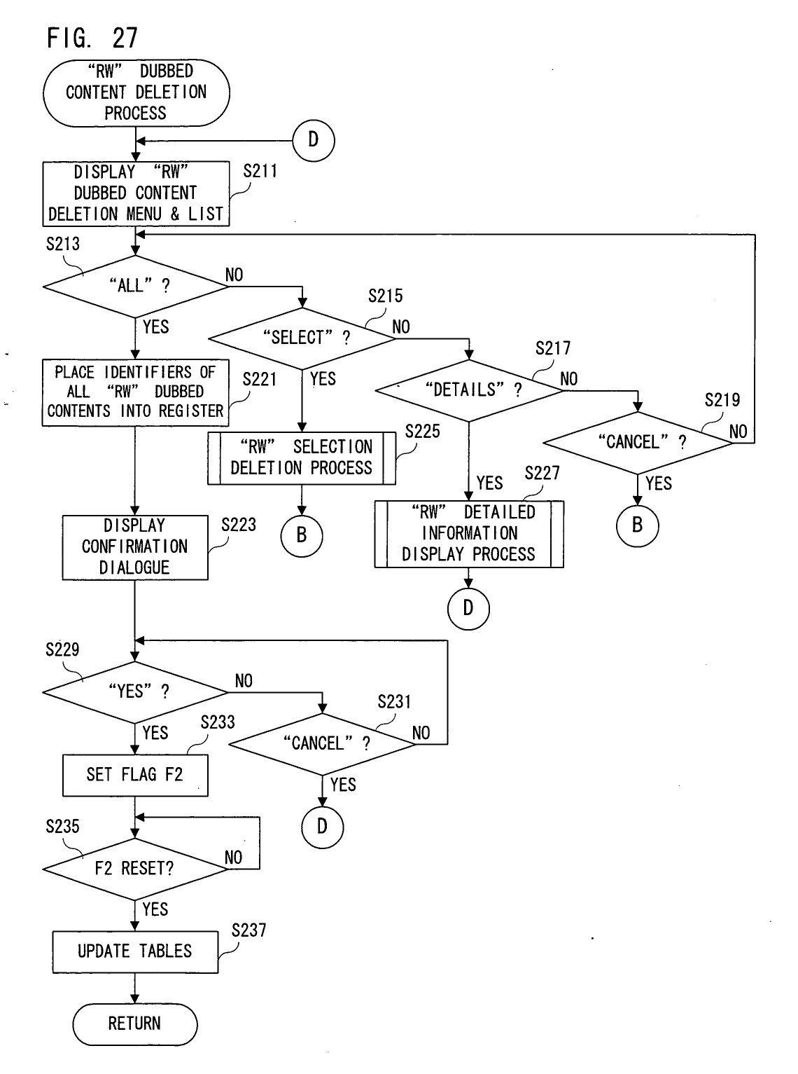

When “DVD-R” is selected, YES is determined in the step S115, the CPU 28 moves to a step S125 to perform an “R” dubbed content deletion process (see FIG. 24; to be hereinafter described). After that, the process returns to the step S11. When “DVD-RW” is selected, YES is determined in the step S117 and the CPU 28 moves to the step S127 to perform an “RW” dubbed content deletion process (see FIG. 27; to be described later). Then, the process returns to the step S11. When “Cancel” is selected, YES is determined in the step S119 and the process returns to a higher-layer routine.

Referring to FIG. 24, in the “R” dubbed content deletion process, the CPU 28 firstly displays the “R” dubbed content deletion menu together with the “R” dubbed contents list in a step S151 (see FIG. 13). Then, the CPU 28 enters a loop of steps S153 to S159 to wait until any one of the options “All”, “Select”, “Details” and “Cancel” is selected.

When “All” is selected, YES is determined in the step S153, and the CPU 28 moves to a step S161 to place the identifier for all the “R” dubbed contents into the register 28r. In a next step S163, the CPU 28 displays a dialogue for confirming whether or not to collectively delete all the “R” dubbed contents (see FIG. 14). Then the CPU 28 enters a loop of steps S169 and S171 to wait until either “Yes” or “Cancel” is selected. When “Yes” is selected, the process proceeds to a step S173. When “Cancel” is selected, the process returns to the step S151.

The CPU 28 sets the flag F2 in a step S173 and waits for the flag F2 to be reset in a next step S175. When the flag F2 is reset, the CPU 28 moves to a step S177 to update the tables T1 and T2. Accordingly, the information corresponding to the contents “A” and “G” is deleted from each of the tables T1 and T2. After the table update, the process returns to a higher-layer routine.

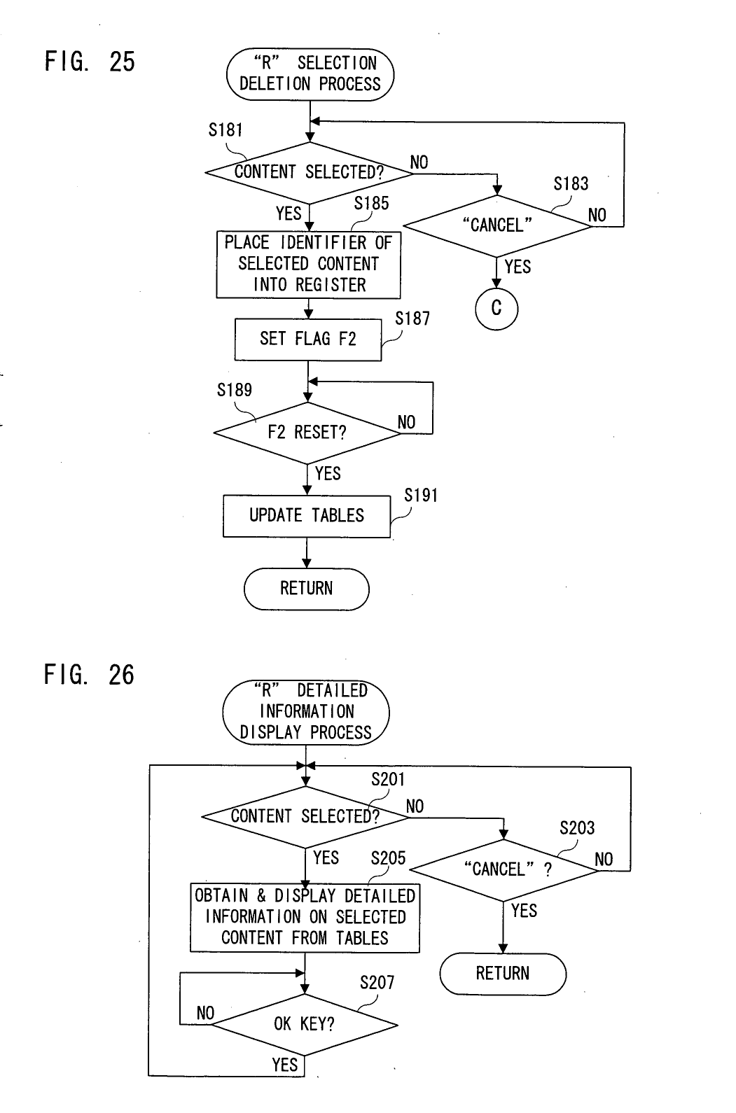

When “Select” is selected, YES is determined in a step S155, and the CPU 28 moves to a step S165 to perform an “R” selection deletion process (see FIG. 25; to be hereinafter described). After that, the process returns to the step S111. When “Details” is selected, YES is determined in a step S157, the CPU 28 goes to a step S167 to perform an “R” detailed information display process (see FIG. 26; to be described later). Then, the process returns to the step S151. When “Cancel” is selected, YES is determined in a step S159, and the CPU 28 returns to the step S111.

Referring to FIG. 25, in the “R” selection deletion process, the CPU 28 waits for a selection operation in steps S181 and S183. When any content is selected from the “R” contents list, YES is determined in the step S181 and the process moves to a step S185. When “Cancel” is selected, YES is determined in the step S183, the CPU 28 returns to the step S151.

The CPU 28 places the identifier for the selected content into the register 28r in a step S185, and sets the flag F2 in a next step S187. Then, the CPU 28 moves to a step S189 to wait until the flag F2 is reset. When the flag F2 is reset, the CPU 28 updates the tables T1 and T2 in a step S191. After that, the CPU 28 returns to the state of waiting for a selection operation of the steps S181 and S183.

Referring to FIG. 26, in the “R” detailed information display process, the CPU 28 firstly waits for a selection operation in a loop of steps S201 and S203. When any content is selected from the “R” contents list, YES is determined in the step S201 and the process goes to a step S205. When “Cancel” is selected, YES is determined in the step S203 and the process returns to a higher-layer routine.

In the step S205, the CPU 28 obtains the detailed information on the selected content from the tables T1 and T2, and displays the obtained detailed information (not illustrated). Subsequent to that, the CPU 28 proceeds to a step S207 to wait for the OK key 26b to be pressed. When the OK key 26b is pressed, the CPU 28 returns to the loop of the steps S201 and S203.

Referring to FIG. 27, in the “RW” dubbed content deletion process, the CPU 28 firstly displays the “RW” dubbed content deletion menu together with the “RW” dubbed contents list in a step S211 (see FIG. 15). Then, the CPU 28 enters a loop of steps S213 to S219 to wait until any one of the options “All”, “Select”, “Details” and “Cancel” is selected.

When “All” is selected, YES is determined in the step S213, and the CPU 28 moves to a step S221 to place the identifiers for all the “RW” dubbed contents into the register 28r. In a next step S223, the CPU 28 displays a dialogue for confirming whether or not to collectively delete all the “RW” dubbed contents (not illustrated). Then, the CPU 28 enters a loop of steps S229 and S231 to wait until either “Yes” or “Cancel” is selected. When “Yes” is selected, the process proceeds to a step S233. When “Cancel” is selected, the process returns to the step S231.

The CPU 28 sets the flag F2 in the step S233 and waits until the flag F2 is reset in a next step S235. When the flag F2 is reset, the CPU 28 proceeds to a step S237 to update the tables T1 and T2. Due to this, the information corresponding to the contents “C”, “E” and “I” is deleted from each of the tables T1 and T2. After the table update, the process returns to a higher-layer routine.

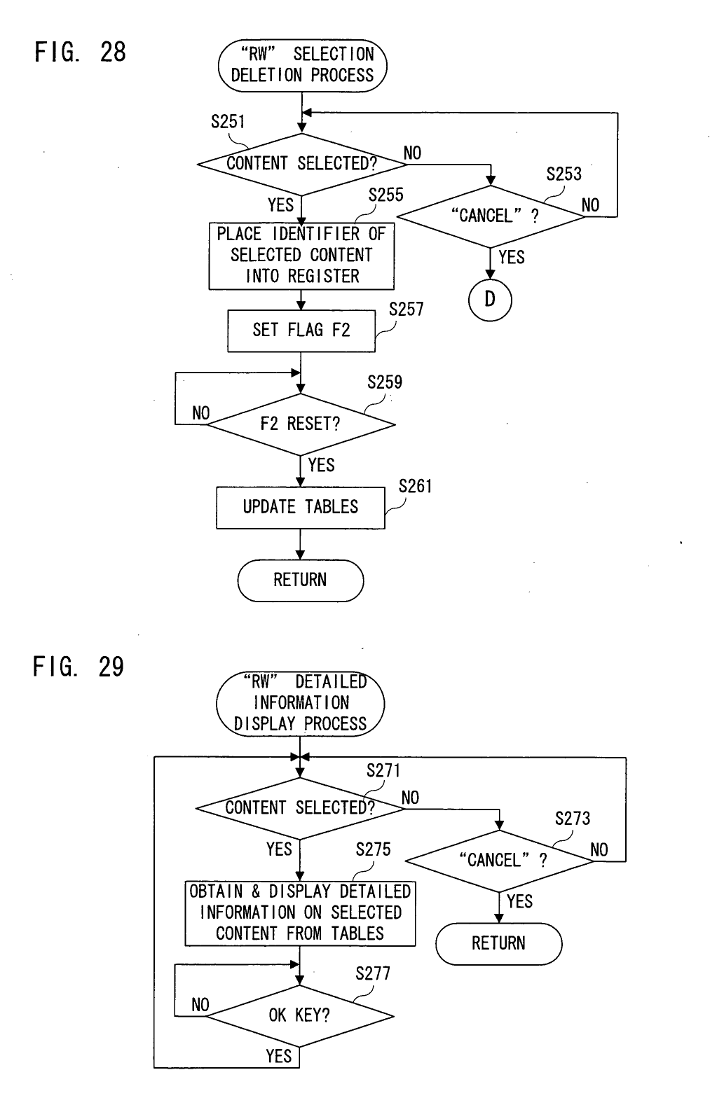

When “Select” is selected, YES is determined in a step S215 and the CPU 28 moves to a step S225 to perform an “RW” selection deletion process (see FIG. 28; to be hereinafter described). After that, the process returns to the step S111. When “Details” is selected, YES is determined in the step S217 and the CPU 28 moves to a step S227 to perform an “RW” detailed information display process (see FIG. 29; to be described later). Then, the process returns to the step S211. When “Cancel” is selected, YES is determined in the step S219 and the process returns to the step S111.

Referring to FIG. 28, in the “RW” selection deletion process, the CPU 28 waits for a selection operation in steps S251 and S253. When any content is selected from the “RW” contents list, YES is determined in the step S251 and the process moves to a step S255. When “Cancel” is selected, YES is determined in the step S253 and the process returns to the step S211.

The CPU 28 places the identifier for the selected content into the register 28r in the step S255 and sets the flag F2 in a next step S257. Then, the CPU 28 proceeds to a step S259 to wait until the flag F2 is reset. When the flag F2 is reset, the CPU 28 updates the tables T1 and T2 in a step S261. After that, the CPU 28 returns to the state of waiting the selection operation of the steps S251 and S253.

Referring to FIG. 29, in the “RW” detailed information display process, the CPU 28 firstly waits for a selection operation in a loop of steps S271 and S273. When any content is selected from the “RW” contents list, YES is determined in a step S271 and the process moves to a step S275. When “Cancel” is selected, YES is determined in the step S273 and the process returns to a higher-layer routine.

In the step S275, the CPU 28 obtains the detailed information on the selected content from the tables T1 and T2, and displays the obtained detailed information. After that, the CPU 28 moves to a step S277 to wait for a press of the OK key 26b. When the OK key 26b is pressed, the process returns to the loop of the steps S271 and S273.

Referring to FIG. 30, in the dubbing task, the CPU 28 determines in a step S291 whether the flag F1 is set or not. When the flag F1 is set, the CPU 28 moves to a step S293 to dub an image file corresponding to the identifier placed in the register 28r from the HD 18a to the DVD 20a. In a next step S293, the CPU 28 clears the register 28r and resets the flag F1. After that, the process returns to the step S291.

Referring to FIG. 31, in the content deleting task, the CPU 28 determines in a step S301 whether the flag F2 is set or not. When the flag F2 is set, the CPU 28 moves to a step 303 to delete an image file corresponding to the identifier placed in the register 28r from the HD 18a. In a next step S305, the CPU 28 clears the register 28r and resets the flag F2. Subsequent to that, the process returns to the step S301.

As obvious from the above descriptions, in this embodiment, registered on the contents table T1 is the attribute information on a plurality of contents recorded on the HD 18a, such as titles, genres, recording dates and times, and time lengths. Registered on the deleted contents table T2 are the dubbing destinations for contents copied to the DVD 20a, out of the plurality of contents recorded on the HD 18a.

The TV monitor 24 displays the deletion supporting screens (see FIG. 4 to FIG. 17) based on the attribute information registered on the contents tables T1 and T2. The operator determines whether or not the copied contents are necessary one by one through these screens, and performs the operation of collectively deleting the copied contents that has been determined to be unnecessary or the operation of individually deleting such copied contents. Accordingly, the CPU 28 issues to the HDD 18 an instruction for deleting the relevant copied content(s) from the HD 18a.

In other words, it is possible to accurately determine a copied content is necessary or not through the deletion supporting screens. It is also possible to delete the copied content(s) that have been determined to be unnecessary with an easy operation. For example, if it is determined that none of the copied contents are necessary, it is possible to collectively delete all the copied contents from the HD 18a. Also, even though it is impossible to collectively delete all the copied contents, if it is determined that the contents copied to the “R” type DVD 20a, out of the copied contents, are all unnecessary, it is possible to collectively delete all the “R” copied contents.

Additionally, although this embodiment uses the hard disk 18a as an internal recording medium, semi-conductor memories and optical disks may be employed instead. Moreover, this embodiment uses the DVD 20a as an external recording medium, and compact disks and floppy disks may be utilized in place of it.

Up to this point, descriptions are given as to the recorder 10 of one embodiment of the present invention. The present invention may be applied to various apparatuses with the capability of copying to an external medium an arbitrary one of a plurality of contents recorded on an internal recording medium.

Although the present invention has been described and illustrated in detail, it is clearly understood that the same is by way of illustration and example only and is not to be taken by way of limitation, the spirit and scope of the present invention being limited only by the terms of the appended claims.

1. A content copying apparatus comprising:
a copier for copying to an external recording medium an arbitrary one of a plurality of contents recorded on an internal recording medium;
a discriminator for discriminating a recording type of the external recording medium to which copying is performed by said copier;
a generator for generating copied content information in which an attribute of the content copied by said copier and the recording type discriminated by said discriminator are described; and
an outputter for outputting supporting information for supporting an operation of deleting the copied content recorded on said internal recording medium based on the copied content information generated by said generator.

2. A content copying apparatus according to claim 1, wherein
said outputter outputs said supporting information in different forms according to the recording type described in said copied content information.

3. A content copying apparatus according to claim 1 further comprising:
an acceptor for accepting a deletion instruction in which a desired recording type is designated; and
a deleter for collectively deleting from said internal recording medium the contents copied to the external recording medium of said designated recording type when said acceptor has accepted said deletion instruction.

4. A content copying apparatus according to claim 1, wherein
said recording type defines whether or not said external recording medium is rewritable.

5. A content copying apparatus according to claim 1, wherein
said attribute includes at least any one of content name, genre, recording date, and time length.

6. A content copying apparatus according to claim 1 further comprising:
a placer for placing into a copied contents list attribute information of the content copied by said copier; and
a collective deleter for deleting all the copied contents from said internal recording medium by referring to said copied contents list when a collective deletion operation has been accepted.

7. A content copying method comprising:
a copying step of copying to an external recording medium an arbitrary one of a plurality of contents recorded on an internal recording medium;
a discriminating step of discriminating a recording type of the external recording medium to which copying is performed in said copying step;
a generating step of generating copied content information in which an attribute of the content copied in said copying step and the recording type discriminated in said discriminating step are described; and
an outputting step of outputting the supporting information for supporting the operation of deleting the copied content recorded on said internal recording medium based on the copied content information generated in said generating step.

8. A content copying apparatus comprising:
a copier for copying to an external recording medium an arbitrary one of a plurality contents recorded on an internal recording medium;
a placer for placing into a copied contents list attribute information of the content copied by said copier; and
a collective deleter for deleting all the copied contents from said internal recording medium by referring to said copied contents list when a collective deletion operation has been accepted.

9. A content copying method comprising:
a copying step of copying to an external recording medium an arbitrary one of a plurality of contents recorded on an internal recording medium;
a placing step of placing into a copied contents list attribute information of the content copied in said copying step; and
a collective deleting step of deleting all the copied contents from said internal recording medium by referring to said copied contents list when it has accepted an collective deletion operation.
